(19) United States
(12) Patent Application Publication
(10) Pub. No.: US 2026/0337377 A1
(43) Pub. Date: Oct. 29, 2026

(54) STRETCHABLE ELECTROCHROMIC DEVICE COMPOSITION, METHOD FOR MANUFACTURING ELECTROCHROMIC MEMBER, AND STRETCHABLE ELECTROCHROMIC DEVICE MANUFACTURED THEREBY

(71) Applicant: Korea University of Technology and Education Industry-University Cooperation Foundation, Cheonan-si (KR)

(72) Inventors: Jin Woo BAE, Seoul (KR); Jaeuk YOON, Yongin-si (KR); Insun WOO, Cheongju-si (KR); Seung Ju OH, Cheonan-si (KR)

(73) Assignee: Korea University of Technology and Education Industry-University Cooperation Foundation, Cheonan-si (KR)

(21) Appl. No.: 19/665,057

(22) Filed: May 1, 2026

Related U.S. Application Data
(63) Continuation of application No. PCT/KR2024/015254, filed on Oct. 8, 2024.

(30) Foreign Application Priority Data
Nov. 24, 2023 (KR) 10-2023-0165298
Nov. 24, 2023 (KR) 10-2023-0165306

(51) Int. Cl. C08K 5/109; C08J 3/21; C08K 5/11; C09K 9/02; G02F 1/1516

(52) U.S. Cl. CPC C08K 5/109; C08J 3/212; C08K 5/11; C09K 9/02; G02F 1/15165; C08J 2327/06; C09K 2211/1018

(57) ABSTRACT

The present invention relates to a stretchable electrochromic device composition, a method for manufacturing an electrochromic member, and a stretchable electrochromic device manufactured through the same. The electrochromic device composition according to an embodiment of the present invention includes a polymer resin, a color-changing material, and a plasticizer. In an embodiment, the plasticizer includes a primary plasticizer and propylene carbonate (PC). In another embodiment, the plasticizer includes a primary plasticizer, propylene carbonate (PC), and ethylene carbonate (EC).

### CROSS-REFERENCE TO RELATED APPLICATION

This application is a continuation application under 35 U.S.C. § 111(a) of International Patent Application No. PCT/KR2024/015254, filed Oct. 8, 2024, which claims priority to Korean Patent Application No. 10-2023-0165306, filed Nov. 24, 2023, and Korean Patent Application No. 10-2023-0165298, filed Nov. 24, 2023, of which the entire contents of each are incorporated herein by reference.

### BACKGROUND

The present invention relates to a stretchable electrochromic device composition, a method for manufacturing an electrochromic member, and a stretchable electrochromic device manufactured through the same. The present invention includes propylene carbonate (PC), or includes propylene carbonate and ethylene carbonate EC.

The present invention is the result of the project ‘Development of plasticized polymer-based dielectric and ion conductors and application to next generation organic electronic devices using 3D printing’, which was conducted in 2024 with funding from the Ministry of Science and ICT and support from the National Research Foundation of Korea (RS-2024-00348475).

An electrochromic device is a device that includes an electrochromic material and that changes color in response to a voltage applied from the outside. Various materials such as polymer compounds and metal oxides are applied to the electrochromic material, and the color changes reversibly in response to the voltage applied to an electrode.

Recently, the fields in which this electrochromic device is applied are expanding, for example, the electrochromic device is used for a smart window system that blocks outside views and sunlight, vehicular glass that displays information such as maps and letters, or the like.

Since an electrochromic material in a liquid state was used for a conventional electrochromic device, there was a problem of causing leakage of an electrolyte solution, and there were limitations to using it for a flexible display. Recently, a solidified water-based electrolyte solution has been developed, but water evaporates easily, so that there was a problem that a protection layer needs to be further installed in order to prevent the evaporation of water.

Prior art includes Korean Registered Patent Publication No. 10-2078481.

### SUMMARY

The present invention provides a stretchable electrochromic device composition with improved color efficiency and speed of color change, a method for manufacturing an electrochromic member, and a stretchable electrochromic device manufactured through the same.

The present invention also provides light transmittance and elasticity.

The present invention also provides long lifetime and excellent durability.

Furthermore, due to flexibility and elasticity, application in various fields is possible.

Furthermore, since the manufacturing method is simple, it is possible to increase the production efficiency and reduce the manufacturing cost.

In accordance with an exemplary embodiment of the present invention, an electrochromic device composition includes a polymer resin, a color-changing material, and a plasticizer. In an embodiment, the plasticizer is a primary plasticizer and propylene carbonate (PC). In another embodiment, the plasticizer is a primary plasticizer, propylene carbonate (PC), and ethylene carbonate (EC).

When the plasticizer is a primary plasticizer and propylene carbonate, the propylene carbonate may be included in an amount of approximately 3 to 11 wt % on the basis of the weight of the primary plasticizer.

When the plasticizer is a primary plasticizer, propylene carbonate, and ethylene carbonate, the propylene carbonate may be included in an amount of approximately 2 to 8 wt % on the basis of the weight of the primary plasticizer, and the ethylene carbonate may be included in an amount of approximately 2 to 8 wt % on the basis of the weight of the primary plasticizer.

When the plasticizer is a primary plasticizer and propylene carbonate, the propylene carbonate may be included in an amount of approximately 35 to 85 wt % on the basis of the weight of the polymer resin.

When the plasticizer is a primary plasticizer, propylene carbonate, and ethylene carbonate, the propylene carbonate may be included in an amount of approximately 25 to 75 wt % on the basis of the weight of the polymer resin, and the ethylene carbonate may be included in an amount of approximately 25 to 75 wt % on the basis of the weight of the polymer resin.

When the plasticizer is a primary plasticizer, propylene carbonate, and ethylene carbonate, the weight ratio of the propylene carbonate and the ethylene carbonate may be approximately 3:1 to 1:3.

The primary plasticizer may be dibutyl adipate (DBA)

In accordance with another exemplary embodiment of the present invention, a method for manufacturing an electrochromic member includes: dissolving a polymer resin in a solvent to prepare a mixture; adding a plasticizer to the mixture; and adding a color-changing material to the mixture. In an embodiment, the plasticizer is a primary plasticizer and propylene carbonate (PC). In another embodiment, the plasticizer is a primary plasticizer, propylene carbonate (PC), and ethylene carbonate (EC).

In accordance with another exemplary embodiment of the present invention, an electrochromic device includes an electrochromic device layer, and the electrochromic device layer is prepared by drying an electrochromic device composition containing a polymer resin, a color-changing material, and a plasticizer. In an embodiment, the plasticizer is a primary plasticizer and propylene carbonate (PC). In another embodiment, the plasticizer is a primary plasticizer, propylene carbonate (PC), and ethylene carbonate (EC).

### BRIEF DESCRIPTION OF THE DRAWINGS

Exemplary embodiments can be understood in more detail from the following description taken in conjunction with the accompanying drawings, in which:

FIG. 1 is a drawing illustrating a method for manufacturing an electrochromic member according to an embodiment of the present invention;

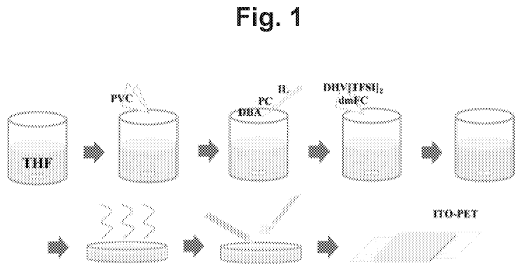

FIG. 2 shows the result of measuring ionic conductivity for an electrochromic member manufactured according to an embodiment;

FIG. 3 shows the result of measuring transmittance for an electrochromic member manufactured according to an embodiment;

FIG. 4 shows color efficiency of an electrochromic member manufactured according to an embodiment;

FIG. 5 is a drawing illustrating a method for manufacturing an electrochromic member according to another embodiment of the present invention;

FIG. 6 shows the result of measuring ionic conductivity for an electrochromic member manufactured according to another embodiment;

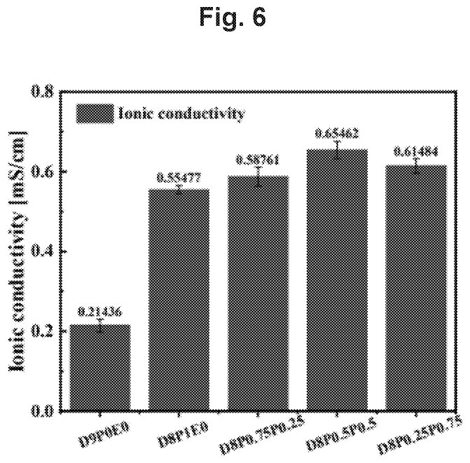

FIG. 7 shows the result of measuring transmittance for an electrochromic member manufactured according to another embodiment; and

FIG. 8 shows color efficiency of an electrochromic member manufactured according to another embodiment.

### DETAILED DESCRIPTION OF EMBODIMENTS

Hereinafter, preferred embodiments of the present invention are described as follows with reference to the accompanying drawings. However, the embodiments according to the present invention may be modified into various other forms, and the scope of the present invention should not be construed as being limited to the embodiments to be described below. In addition, the embodiments of the present invention are provided to more completely explain the present invention to those with average knowledge in the art.

### Electrochromic Device Composition

An electrochromic device composition according to an embodiment of the present invention includes a polymer resin, a color-changing material, and a plasticizer. In an embodiment, the plasticizer is a primary plasticizer and propylene carbonate (PC). In another embodiment, the plasticizer is a primary plasticizer, propylene carbonate (PC), and ethylene carbonate (EC).

The polymer resin forms a basic body in the electrochromic device composition. The polymer resin may have light transmittance, flexibility, and elasticity when plasticized by the plasticizer. To this end, the polymer resin may be at least one of polyvinyl chloride (PVC), polytetrafluoroethylene (PTFE), polyurethane (PU), polymethyl methacrylate (PMMA), polydimethyl siloxane (PDMS), polyvinyl alcohol (PVA), polyvinyl pyrrolidone (PVP), polyethylene oxide (PEO), polyimide (PI), or polyethylene terephthalate (PET). In particular, by using polyvinyl chloride (PVC), high light transmittance, flexibility, and elasticity may be achieved. The polyvinyl chloride may be expressed by Structural Formula 1 below.

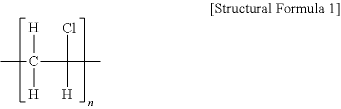

(n is a natural number)

In an embodiment, a primary plasticizer and propylene carbonate (PC) are included as the plasticizer. In another embodiment, a primary plasticizer, propylene carbonate (PC), and ethylene carbonate (EC) are included as the plasticizer. The plasticizer is a material that plasticizes the polymer resin.

The primary plasticizer may be dibutyl adipate (DBA), but is not particularly limited thereto.

The dibutyl adipate may be expressed by Structural Formula 2 below.

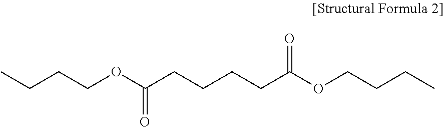 [SMILES: CCCCOC(=O)CCCCC(=O)OCCCC]

The primary plasticizer may be included in an amount of approximately 700 to 1200 parts by weight, preferably approximately 700 to 1000 parts by weight, and more preferably approximately 700 to 900 parts by weight on the basis of 100 parts by weight of the polymer resin. If the amount of the primary plasticizer is too low, crystals may be easily generated in the prepared electrochromic device, and if the amount of the primary plasticizer is too high, mechanical property may be reduced.

The propylene carbonate (PC) increases ionic conductivity of the electrochromic device, thereby improving the speed of color change and color efficiency. The propylene carbonate may be expressed by Structural Formula 3.

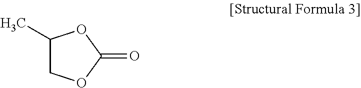

In case of an embodiment where a primary plasticizer and propylene carbonate are included as the plasticizer, the propylene carbonate may be included in an amount of approximately 3 to 11 wt %, and preferably approximately 10 to 10.5 wt % on the basis of the weight of the primary plasticizer. In addition, the propylene carbonate may be included in an amount of approximately 35 to 85 wt %, and preferably approximately 80 to 85 wt % on the basis of the weight of the polymer resin. If the amount of propylene carbonate is too high, leakage and cloudy-gel phenomenon may occur, and if the amount is too low, ionic conductivity may not be sufficiently improved.

In case of another embodiment where a primary plasticizer, propylene carbonate, and ethylene carbonate are included as the plasticizer, the propylene carbonate may be included in an amount of approximately 2 to 8 wt %, and preferably approximately 4 to 6 wt % on the basis of the weight of the primary plasticizer. In addition, the propylene carbonate may be included in an amount of approximately 25 to 75 wt % on the basis of the weight of the polymer resin. If the amount of propylene carbonate is too high, leakage and cloudy-gel phenomenon may occur, and if the amount is too low, ionic conductivity may not be sufficiently improved.

The ethylene carbonate (EC) is a material having high dielectric permittivity, which increases the number of free ions of the electrochromic device. The ethylene carbonate may be expressed by Structural Formula 4.

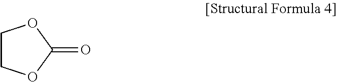

In case of another embodiment where a primary plasticizer, propylene carbonate, and ethylene carbonate are included as the plasticizer, the ethylene carbonate may be included in an amount of approximately 2 to 8 wt %, and preferably approximately 4 to 6 wt % on the basis of the weight of the primary plasticizer. In addition, the ethylene carbonate may be included in an amount of approximately 25 to 75 wt % on the basis of the weight of the polymer resin. If the amount of ethylene carbonate is too high, it does not dissolve, so that is a problem where a solid forms on the surface of a gel, and if the amount is too low, ionic conductivity is not sufficiently improved.

In another embodiment, the weight ratio of the propylene carbonate and ethylene carbonate may be approximately 3:1 to 1:3, preferably, approximately 6:4 to 4:6, and more preferably, approximately 1:1. Within this amount range, the electrochromic device has the most excellent ionic conductivity, speed of color change, and color efficiency.

In an embodiment of the present application, the color-changing material may be a material that is used for changing color of the polymer gel, and DHV[TFSI]₂ may be used according to an embodiment of the present invention, but the material is not limited thereto. Meanwhile, the DHV[TFSI]₂ may be expressed by Structural Formula 5 below.

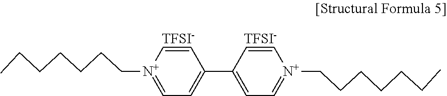

The color-changing material may be included in an amount of approximately 5 to 100 parts by weight, and preferably, approximately 10 to 20 parts by weight on the basis of 100 parts by weight of the polymer resin.

The electrochromic device composition may further include an ionic liquid. The ionic liquid is a material that can improve movement of ions and electrons while maintained in a non-volatile liquid state generally at a temperature of 100 °C or less. Various types may be used for the ionic liquid, but preferably, 1-ethyl-3-methylimidazolium bis(trifluoromethyl sulfonyl)imide (EMIM-TFSI) may be used. By limiting the ionic liquid as above, high light transmittance of an electrochromic device layer may be maintained. The EMIM-TFSI may be expressed by Structural Formula 6 below.

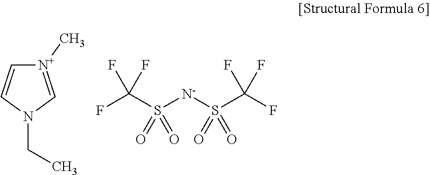

The ionic liquid may be included in an amount of approximately 100 to 200 parts by weight, and preferably approximately 110 to 130 parts by weight on the basis of 100 parts by weight of the polymer resin. If the amount of ionic liquid is too high, transmittance may be reduced.

The electrochromic device composition may further include a reductant, and the reductant may be an anode redox compound. The anode redox compound may be any one among ferrocene and dimethyl ferrocene (dmFC), and preferably dimethyl ferrocene. The dimethyl ferrocene may be expressed by Structural Formula 7 below.

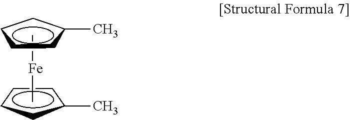

The anode redox compound may be included in an amount of approximately 1 to 20 parts by weight, and preferably approximately 12 to 18 parts by weight on the basis of 100 parts by weight of the polymer resin.

### Method for Manufacturing Electrochromic Member

A method for manufacturing an electrochromic member according to an embodiment of the present invention includes dissolving a polymer resin in a solvent to prepare a mixture; adding a plasticizer to the mixture; and adding a color-changing material to the mixture. In an embodiment, the plasticizer is a primary plasticizer and propylene carbonate (PC). In another embodiment, the plasticizer is a primary plasticizer, propylene carbonate (PC), and ethylene carbonate (EC). The present invention may further include adding an additive such as an ionic liquid and a reductant. In addition, removing the solvent from the mixed solution may be further included.

Description on the polymer resin, primary plasticizer, propylene carbonate, ionic liquid, reductant, etc. are the same as described previously.

The dissolving of the polymer resin in a solvent to prepare a mixture is performed by mixing the polymer resin in the solvent and agitating the mixture. The solvent may be a polar organic solvent. This is for easily dissolving the polymer resin such as PVC. The polar organic solvent may be any one among dioxane, tetrahydrofuran (THF), acetone, dimethyl sulfoxide (DMSO), dimethylformamide (DMF), and 1-methyl-2-pyrrolidone (NMP). The solvent may be used in an amount that is sufficient to dissolve the polymer resin. This step may be performed at room temperature.

In the adding of a plasticizer to the mixture, in case of an embodiment, the plasticizer is a primary plasticizer and propylene carbonate (PC), and in case of another embodiment, the plasticizer is a primary plasticizer, propylene carbonate (PC), and ethylene carbonate (EC). Although the plasticizers may be mixed regardless of the order, efficiency in plasticization and ionic conductivity of the polymer resin may be improved by preferably adding the primary plasticizer first. In this case, this step may include adding the primary plasticizer to the mixture, and adding propylene carbonate or adding propylene carbonate and ethylene carbonate to a mixture in which the primary plasticizer is added.

In case of an embodiment, in the adding of the primary plasticizer to the mixture, the primary plasticizer may be included in an amount of approximately 700 to 1200 parts by weight, preferably approximately 700 to 1000 parts by weight, and more preferably approximately 750 to 850 parts by weight on the basis of 100 parts by weight of the polymer resin.

In case of another embodiment, in the adding of the primary plasticizer to the mixture, the primary plasticizer may be included in an amount of approximately 700 to 1200 parts by weight, preferably approximately 700 to 1000 parts by weight, and more preferably approximately 700 to 900 parts by weight on the basis of 100 parts by weight of the polymer resin. The adding of propylene carbonate and ethylene carbonate to a mixture in which the primary plasticizer is added may be performed by first mixing and agitating propylene carbonate and ethylene carbonate, and then adding the propylene carbonate and ethylene carbonate to the mixture in which the primary plasticizer is added.

The adding of a color-changing material to the mixture may be performed by directly adding the color-changing material to the mixture. In addition, the color-changing material may be dissolved in a solvent to prepare a color-changing material solution, and then the color-changing material solution may be mixed in the mixture previously prepared. The solvent may be a material that can dissolve the color-changing material, which may vary according to the color-changing material. The solvent may be any one among dioxane, tetrahydrofuran (THF), acetone, dimethyl sulfoxide (DMSO), dimethylformamide (DMF), and 1-methyl-2-pyrrolidone (NMP).

The present invention may further include adding an additive such as an ionic liquid and a reductant. Each step may be performed regardless of the previous steps and the order thereof. Preferably, the steps may be performed after the mixing of the plasticizer.

The removing of the solvent from the mixed solution may be performed by drying the mixture at room temperature or in an oven.

### Electrochromic Device

An electrochromic device according to an embodiment of the present invention includes: a first electrode; a second electrode; and an electrochromic device layer that changes color in response to a voltage by the first electrode and the second electrode, and the electrochromic device layer includes the electrochromic device composition previously described.

The first electrode and the second electrode are electrodes generally used in an electric device, and not particularly limited. However, the electrodes may include ITO glass, ITO-PEN, or the like in order to have light transmittance and flexibility.

The electrochromic device layer may include the electrochromic device composition previously described, and may be prepared from the electrochromic device composition in an appropriate size and thickness according to the method for manufacturing the electrochromic member previously described.

In an embodiment, the electrochromic device layer may be prepared by drying the electrochromic device composition containing a polymer resin, a color-changing material, a primary plasticizer, and propylene carbonate (PC). In another embodiment, the electrochromic device layer may be prepared by drying the electrochromic device composition containing a polymer resin, a color-changing material, a primary plasticizer, propylene carbonate (PC), and ethylene carbonate (EC).

Description on the polymer resin, primary plasticizer, propylene carbonate, ethylene carbonate, ionic liquid, reductant, etc. are the same as described previously.

### Example: Manufacturing of Electrochromic Member According to Embodiment

Example 1 (D8.5P0.5): a product of Scientific Polymer Products, Inc. for PVC, a product of TCI for DBA, a product of Daejung Chemicals & Metals CO., LTD. for PC, a product of io-li-tec for EMIM-TFSI, a product of TCI for dmFC, and a product of Daejung Chemicals & Metals CO., LTD. for THE as a solvent were used. 0.3531 g of PVC was agitated and dissolved in 25 mL of THF at room temperature, and then 3.0012 g of DBA was added thereto and agitated. 0.1471 g of PC was added thereto, 0.4237 g of EMIM-TFSI, 0.2483 g of DHV[TFSI]₂, and 0.0581 g of dmFC were added thereto, and agitated at room temperature. The agitated mixture was poured into a Petri dish, and dried for approximately 24 hours at room temperature. The prepared electrochromic member was a gel-type film having a thickness of approximately 0.5 mm.

Example 2 (D8P1): an electrochromic member was prepared in the same manner as that of Example 1, except that 0.3545 g of PVC, 2.8358 g of DBA, 0.2954 g of PC, and 0.4254 g of EMIM-TFSI were used.

Comparative Example 1 (D9P0): an electrochromic member was prepared in the same manner as that of Example 1, except that 0.3517 g of PVC, 3.1653 g of DBA, and 0.4220 g of EMIM-TFSI were used, and PC was not added.

Comparative Example 2 (D7.5P1.5): an electrochromic member was prepared in the same manner as that of Example 1, except that 0.3559 g of PVC, 2.6691 g of DBA, 0.4448 g of PC, and 0.4271 g of EMIM-TFSI were used.

### Experimental Example: Measurement of Ionic Conductivity

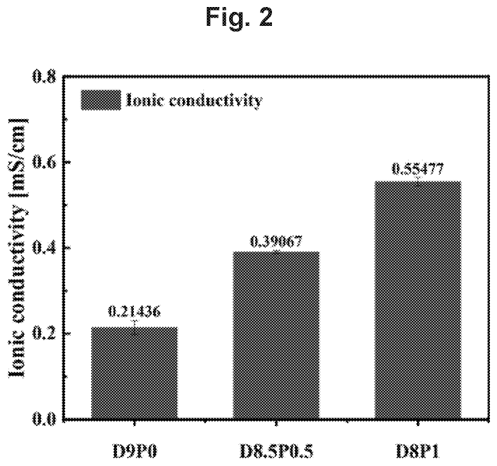

The electrochromic members of Examples 1 and 2 and Comparative Examples 1 and 2 were each cut into a size of 10 mm×10 mm, and then placed on a Pt-coated electrode, and then covered with a Pt-coated electrode. A distance between the electrodes was 0.3 mm. Using a potentiostat (Biologics, SP240), the ionic conductivity was measured in a condition of 10⁵-10⁻¹ Hz and 10 mV AC. The measurement result values were shown in FIG. 2.

Referring to FIG. 2, the ionic conductivity of Example 2 was the most excellent.

### Experimental Example: Measurement of Transmittance

The electrochromic members of Examples 1 and 2 and Comparative Examples 1 and 2 were each cut into a size of 2 cm×2 cm, and then placed on an ITO-PET electrode, and then covered with an ITO-PET electrode to prepare an electrochromic device.

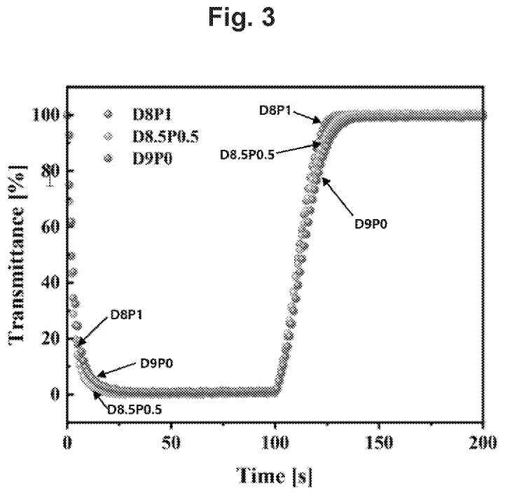

A UV-visible spectrophotometer (Perkin Elmer, Lambda 465) and a potentiostat (Biologics, SP240) were used, and the electrochromic devices of the examples and comparative examples were each set as 100% base line, and the UV-vis spectra was measured in a condition of 607 nm. The measurement result values were shown in FIG. 3.

Referring to FIG. 3, it can be seen that the change in transmittance of Example 2 was the fastest, and thus, the speed of color change was the most excellent.

### Experimental Example: Calculation of Color Efficiency

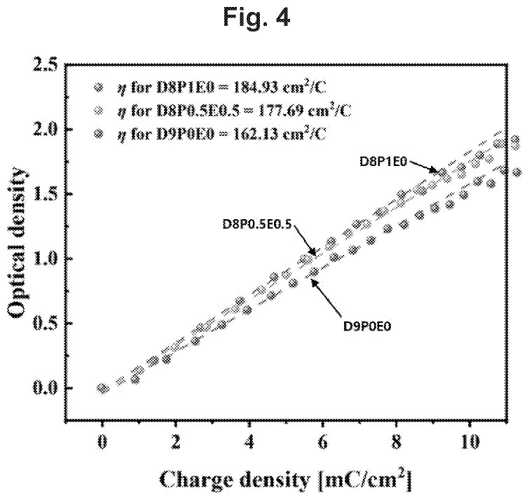

Using the equation below, color efficiency was measured for Examples 1 and 2 and Comparative Example 1, and the result values were shown in Table 1 and FIG. 4.

$$η = \frac{Δ OD}{Δ Q} = \frac{log ( \frac{{T}_{b}}{{T}_{c}} )}{Δ Q} \qquad [ Equation ]$$

(η is a color efficiency, ΔQ is a change amount of charge, ΔOD is a change in optical density at ΔQ, T_{b} is a transmittance in a decolored state, and T_{c} is a transmittance in a colored state).

TABLE 1

| | Ionic | | | | | |
|---|---|---|---|---|---|---|
| | conduc- | | | | | |
| Classifi- | tivity | T_{c, max} | ΔTₘₐₓ | t_{c, 90%} | t_{b, 90%} | η |
| cation | (mS/cm) | (%) | (%) | (s) | (s) | (cm²/C) |
| Comparative | 0.21436 | 0.6 | 99.3 | 13 | 25 | 162.13 |
| Example 1 | | | | | | |
| Example 1 | 0.39067 | 0.1 | 99.9 | 11 | 23 | 177.69 |
| Example 2 | 0.55477 | 0.1 | 99.7 | 11 | 21 | 184.93 |

Referring to Table 1 and FIG. 4, it can be seen that the color efficiency of Example 2 was the most excellent.

### Example: Manufacturing of Electrochromic Member According to Another Embodiment

Example 3 (D8P0.75E0.25): a product of Scientific Polymer Products, Inc. for PVC, a product of TCI for DBA, a product of Daejung Chemicals & Metals CO., LTD. for PC, a product of Daejung Chemicals & Metals CO., LTD. for EC, a product of io-li-tec for EMIM-TFSI, a product of TCI for dmFC, and a product of Daejung Chemicals & Metals CO., LTD. for THE as a solvent were used. First, 0.2216 g of PC and 0.0738 g of EC were mixed at room temperature. 0.3545 g of PVC was agitated and dissolved in 25 mL of THF at room temperature, and then 2.8358 g of DBA was added thereto and agitated. The mixture of PC and EC previously mixed was added thereto, and 0.4254 g of EMIM-TFSI, 0.2483 g of DHV[TFSI]₂, and 0.0581 g of dmFC were added, and agitated at room temperature. The agitated mixture was poured into a Petri dish, and dried for approximately 24 hours at room temperature. The prepared electrochromic member was a gel-type film having a thickness of approximately 0.5 mm.

Example 4 (D8P0.5E0.5): an electrochromic member was prepared in the same manner as that of Example 1, except that 0.1477 g of PC and 0.1477 g of EC were added.

Example 5 (D8P0.25E0.75): an electrochromic member was prepared in the same manner as that of Example 1, except that 0.0738 g of PC and 0.2216 g of EC were added.

Comparative Example 3 (D9P0E0): an electrochromic member was prepared in the same manner as that of Example 1, except that 0.3517 g of PVC, 3.1653 g of DBA, and 0.4220 g of EMIM-TFSI were added, and PC and EC were not added.

Comparative Example 4 (D8P1E0): an electrochromic member was prepared in the same manner as that of Example 1, except that 0.2954 g of PC was added, and EC was not added.

### Experimental Example: Measurement of Ionic Conductivity

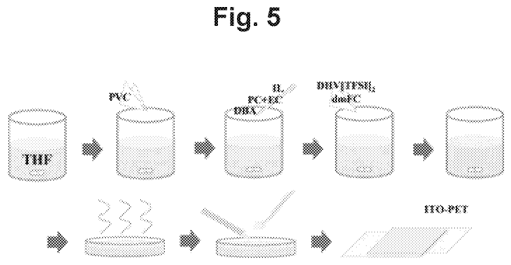

The electrochromic members of Examples 3 to 5 and Comparative Examples 3 and 4 were each cut into a size of 10 mm×10 mm, and then placed on a Pt-coated electrode, and then covered with a Pt-coated electrode. A distance between the electrodes was 0.3 mm. Using a potentiostat (Biologics, SP240), the ionic conductivity was measured in a condition of 10⁵-10⁻¹ Hz and 10 mV AC. The measurement result values were shown in FIG. 5.

Referring to FIG. 5, the ionic conductivity of Example 4 was the most excellent.

### Experimental Example: Measurement of Transmittance

The electrochromic members of Examples 3 to 5 and Comparative Examples 3 and 4 were each cut into a size of 2 cm×2 cm, and then placed on an ITO-PET electrode, and then covered with an ITO-PET electrode to prepare an electrochromic device.

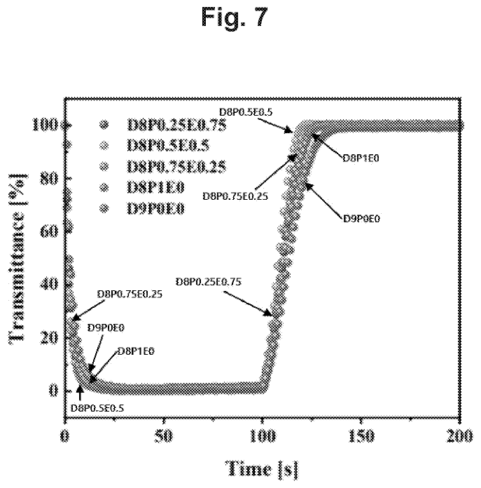

A UV-visible spectrophotometer (Perkin Elmer, Lambda 465) and a potentiostat (Biologics, SP240) were used, and the electrochromic devices of the examples and comparative examples were each set as 100% base line, and the UV-vis spectra was measured in a condition of 607 nm. The measurement result values were shown in FIG. 7.

Referring to FIG. 7, it can be seen that the change in transmittance of Example 4 was the fastest, and thus, the speed of color change was the most excellent.

### Experimental Example: Calculation of Color Efficiency

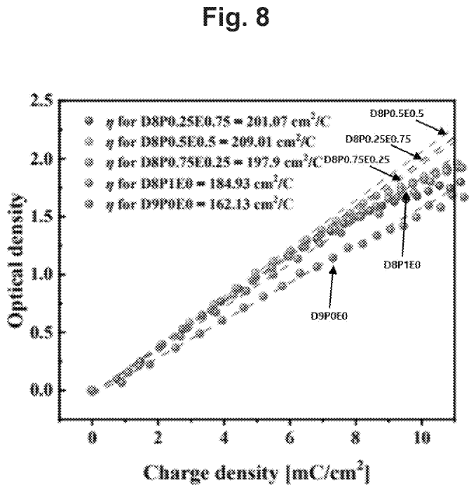

Using the calculation formula above, color efficiency was measured for Examples 3 to 5 and Comparative Examples 3 and 4, and the result values were shown in Table 2 and FIG. 8.

TABLE 2

| | Ionic | | | | | |
|---|---|---|---|---|---|---|
| | conduc- | | | | | |
| Classifi- | tivity | T_{c, max} | ΔTₘₐₓ | t_{c, 90%} | t_{b, 90%} | η |
| cation | (mS/cm) | (%) | (%) | (s) | (s) | (cm²/C) |
| Comparative | 0.21436 | 0.6 | 99.3 | 13 | 25 | 162.13 |
| Example 3 | | | | | | |
| Comparative | 0.55477 | 0.1 | 99.7 | 11 | 21 | 184.93 |
| Example 4 | | | | | | |
| Example 3 | 0.58761 | 0.5 | 99.6 | 10 | 19 | 197.9 |
| Example 4 | 0.65462 | 0.6 | 99.4 | 9 | 16 | 209.01 |
| Example 5 | 0.61484 | 0.1 | 99.8 | 10 | 20 | 201.07 |

Referring to Table 2 and FIG. 8, it can be seen that the color efficiency of Example 4 was the most excellent.

Through a stretchable electrochromic device composition according to an embodiment of the present invention and a method for manufacturing an electrochromic member, a stretchable electrochromic device with improved color efficiency and speed of color change may be provided.

The present invention also provides light transmittance and elasticity.

The present invention also provides long lifetime and excellent durability.

Furthermore, due to flexibility and elasticity, application in various fields is possible.

Furthermore, since the manufacturing method is simple, it is possible to increase the production efficiency and reduce the manufacturing cost.

The present invention is not limited by the embodiments described above and the attached drawings, but is to be limited by the attached claims. Therefore, various forms of substitution, modification, and alteration may be made by those skilled in the art without departing from the technical concept of the present invention stated in the claims, and such are also to be considered to fall within the scope of the present invention.

What is claimed is:

1. An electrochromic device composition, comprising:
a polymer resin;
a color-changing material; and
a plasticizer,
wherein the plasticizer comprises a primary plasticizer and propylene carbonate (PC), or comprises a primary plasticizer, propylene carbonate (PC), and ethylene carbonate (EC).

2. The electrochromic device composition of claim 1,
wherein, when the plasticizer comprises a primary plasticizer and propylene carbonate, the propylene carbonate is included in an amount of approximately 3 to 11 wt % on the basis of the weight of the primary plasticizer.

3. The electrochromic device composition of claim 1,
wherein, when the plasticizer comprises a primary plasticizer, propylene carbonate, and ethylene carbonate, the propylene carbonate is included in an amount of approximately 2 to 8 wt % on the basis of the weight of the primary plasticizer, and
the ethylene carbonate is included in an amount of approximately 2 to 8 wt % on the basis of the weight of the primary plasticizer.

4. The electrochromic device composition of claim 1,
wherein, when the plasticizer comprises a primary plasticizer and propylene carbonate, the propylene carbonate is included in an amount of approximately 35 to 85 wt % on the basis of the weight of the polymer resin.

5. The electrochromic device composition of claim 1,
wherein, when the plasticizer comprises a primary plasticizer, propylene carbonate, and ethylene carbonate, the propylene carbonate is included in an amount of approximately 25 to 75 wt % on the basis of the weight of the polymer resin, and
the ethylene carbonate is included in an amount of approximately 25 to 75 wt % on the basis of the weight of the polymer resin.

6. The electrochromic device composition of claim 1,
wherein, when the plasticizer comprises a primary plasticizer, propylene carbonate, and ethylene carbonate, a weight ratio of the propylene carbonate and the ethylene carbonate is approximately 3:1 to 1:3.

7. The electrochromic device composition of claim 1, wherein the primary plasticizer is dibutyl adipate (DBA).

8. A method for manufacturing an electrochromic member, comprising:
dissolving a polymer resin in a solvent to prepare a mixture;
adding a plasticizer to the mixture; and
adding a color-changing material to the mixture,
wherein the plasticizer comprises a primary plasticizer and propylene carbonate (PC), or comprises a primary plasticizer, propylene carbonate (PC), and ethylene carbonate (EC).

9. An electrochromic device comprising an electrochromic device layer,
wherein the electrochromic device layer is prepared by drying an electrochromic device composition comprising a polymer resin, a color-changing material, and a plasticizer, and the plasticizer comprises a primary plasticizer and propylene carbonate (PC), or comprises a primary plasticizer, propylene carbonate (PC), and ethylene carbonate (EC).
